(19) United States
(12) Patent Application Publication
(10) Pub. No.: US 2015/0248074 A1
(43) Pub. Date: Sep. 3, 2015

(54) RED TONER FOR DEVELOPING ELECTROSTATIC LATENT IMAGE, DEVELOPER AND IMAGE FORMING APPARATUS

(71) Applicants: Kazumi Suzuki, Shizuoka (JP); Hisashi Nakajima, Shizuoka (JP); Masashi Nagayama, Shizuoka (JP); Saori Yamada, Shizuoka (JP); Yoshitaka Yamauchi, Shizuoka (JP); Yu Naito, Shizuoka (JP)

(72) Inventors: Kazumi Suzuki, Shizuoka (JP); Hisashi Nakajima, Shizuoka (JP); Masashi Nagayama, Shizuoka (JP); Saori Yamada, Shizuoka (JP); Yoshitaka Yamauchi, Shizuoka (JP); Yu Naito, Shizuoka (JP)

(21) Appl. No.: 14/625,143

(22) Filed: Feb. 18, 2015

(30) Foreign Application Priority Data
Feb. 28, 2014 (JP) 2014-038350

(51) Int. Cl. G03G 9/00

(52) U.S. Cl. CPC G03G 9/0906

(57) ABSTRACT

A red toner for developing an electrostatic latent image includes a colorant and a binder resin. An image produced by the red toner has a hue angle (H) of from 36 to 50° in L*a*b* color system, a lightness (L*) of from 47 to 55, and a chroma (c*) of from 94 to 108.

### CROSS-REFERENCE TO RELATED APPLICATIONS

This patent application is based on and claims priority pursuant to 35 U.S.C. §119 to Japanese Patent Application No. 2014-038350, filed on Feb. 28, 2014, in the Japan Patent Office, the entire disclosure of which is hereby incorporated by reference herein.

### BACKGROUND

1. Technical Field

The present invention relates to a red toner for developing an electrostatic latent image in electrophotography, electrostatic recording, electrostatic printing, etc., and to a developer including the red toner and an image forming apparatus using the red toner.

2. Description of the Related Art

The electrophotographic method of forming a visual image by developing an electrostatic latent image with a developer includes forming an electrostatic latent image on a photoreceptor including photoconductive material, forming a toner image by developing the electrostatic latent image with a developer including a toner, transferring the toner image onto a recording medium such as papers, and forming a fixed image thereon by fixing the toner image with heat and pressure.

The toner is typically a colored particulate material formed of a binder resin including a colorant, a charge controlling agent and other additives, and is mostly prepared by a pulverization method or a suspension polymerization method.

The pulverization method includes melting, mixing and dispersing a colorant, a charge controlling agent, etc. in a thermoplastic resin to prepare a composition; and pulverizing and classifying the composition to prepare a toner.

In order to save energy and downsize a toner, which is difficult for the pulverization method, chemical toners prepared by the suspension polymerization method, an emulsion polymerization method, a dissolved resin suspension method, etc. are becoming popular.

A toner set which is a combination of a cyan toner, a magenta toner, a yellow toner which are three-color process toners and a black toner is typically used to form a full-color image by the electrophotographic method.

A developing order of the toners when forming a full-color image is not limited, but e.g., light from a document is irradiated on a photoreceptor through a color separation filter or an image read by a scanner is written with a laser irradiation on a photoreceptor to form an electrostatic yellow latent image thereon. The electrostatic yellow latent image is developed with a yellow toner to form a yellow toner image, and which is transferred onto a recording medium such as papers.

However, as the electrophotographic full-color image forming apparatuses become widely used, their applications multifariously expand and demands for their image quality are becoming more severe. Particularly, the red is frequently used for red stamps, and demands for specific color applications unreproducible by combinations of conventional three process colors are increasing.

Japanese published unexamined application No. JP-2009-229659-A discloses a method of using a magenta toner including C. I. Pigment Red 254 to realize high-chroma red having vivid color tone without muddiness. Japanese patent No. JP-4842388-B2 (Japanese published unexamined application No. JP-2011-107676-A) discloses a magenta toner including C. I. Pigment Red 48-3 and C. I. Pigment Red 48-1 in a predetermined ratio, capable of reproducing high-lightness vermilion without using a fluorescent pigment having poor light resistance. Further, Japanese published unexamined application No. JP-2013-101189-A discloses a method of selecting a vermilion colorant and controlling an adherence amount of a vermilion toner to prevent blur thin line and roughness of a stamp image.

Japanese published unexamined applications Nos. JP-2011-242431-A, JP-2010-169843-A, JP-2013-20115-A and JP-2011-186380-A disclose methods of controlling hue angles, etc. in L*a*b* color system to realize a red color image having high chroma and lightness. In these disclosures, a red toner using an independent red color material is used or a special color toner having a color tone of from bright yellow to orange is added.

However, demands for further reproducibility of the vermilion of stamps are increasing, and a red toner having high chroma and lightness is required. Methods of reproducing vermilion include adding an orange toner to a conventional process color toner. A combination of two color toners has insufficient color stability.

In terms of security of preventing falsification by reproducing vermilion color tone used for specific color applications unrealizable with conventional process colors, color areas unreproducible by conventional process colors are not fully satisfied.

### SUMMARY

Accordingly, one object of the present invention is to provide a red toner for developing an electrostatic latent image capable of reproducing red color having high chroma and high lightness unreproducible by conventional process colors.

Another object of the present invention is to provide a developer including the red toner.

A further object of the present invention is to provide an image forming apparatus using the red toner.

These objects and other objects of the present invention, either individually or collectively, have been satisfied by the discovery of a red toner for developing an electrostatic latent image, including a colorant; and a binder resin, wherein an image produced by the red toner has a hue angle (H) of from 36 to 50° in L*a*b* color system, a lightness (L*) of from 47 to 55, and a chroma (c*) of from 94 to 108.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a schematic view illustrating a main part in the embodiment of the image forming apparatus of the present invention;

FIG. 3 is a schematic view illustrating another main part in the embodiment of the image forming apparatus of the present invention; and

FIG. 4 is a schematic view illustrating another embodiment of the image forming apparatus of the present invention.

### DETAILED DESCRIPTION

The present invention provides a red toner for developing an electrostatic latent image capable of reproducing red color having high chroma and high lightness unreproducible by conventional process colors.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

### (Toner)

The red toner for developing an electrostatic latent image (hereinafter referred to as a red toner) of the present invention includes at least a colorant and a binder resin, and may include other components when necessary. An image produced by the red toner of the present invention has a hue angle (H) of from 36 to 50° in L*a*b* color system, a lightness (L*) of from 47 to 55, and a chroma (c*) of from 94 to 108. Thus, a red color having high chroma and high lightness unreproducible by conventional process colors is produced. The image produced by the red toner of the present invention is distinguished from other images. It can be expected as well that propriety of the origin of an image a stamp or a confidential document is produced on can be identified.

In the present invention, the hue angle (H), the lightness (L*) and the chroma (c*) are measured by X-rite 938 from X-rite, Inc.

### <Colorant>

As a colorant (color material) for the red toner, a red pigment satisfying the color area alone may be used, or a yellow pigment, an orange pigment and a magenta pigment may be mixed to reproduce the color area. In terms of color muddiness and reproducibility, it is preferable to use a red color material alone.

The colorant preferably includes at least a compound having a diketopyrrolopyrrole structure or a compound having a perylene structure. The compound having a diketopyrrolopyrrole structure or the compound having a perylene structure may be its isomer.

Specific examples of the compound having a diketopyrrolopyrrole structure include Pigment Red 254, Pigment Red 255, etc.

Specific examples of the compound having a perylene structure include Pigment Red 149, Pigment Red 179, etc.

An azo pigment such as Pigment Red 166 other than the compound having a diketopyrrolopyrrole structure and the compound having a perylene structure may also be used.

The diketopyrrolopyrrole and the perylene are effectively used because of being capable of imparting high chroma without including chlorine.

Among the above, the Pigment Red 149 and the Pigment Red 255 capable of imparting high chroma without including chlorine are preferably used.

Specific examples of the yellow pigment include C.I. Pigment Yellow 74, C.I. Pigment Yellow 139, C.I. Pigment Yellow 155, C.I. Pigment Yellow 180, C.I. Pigment Yellow 185, etc.

Specific examples of the orange pigment include C.I. Pigment Orange 38, C.I. Pigment Orange 43, C.I. Pigment Orange 64, C.I. Pigment Orange 71, C.I. Pigment Orange 72, etc.

Specific examples of the magenta pigment include C.I. Pigment Red 48:1, C.I. Pigment Red 48:3, C.I. Pigment Red 81, C.I. Pigment Red 53:1, C.I. Pigment Red 122, C.I. Pigment Red 238, C.I. Pigment Red 269, etc.

The red toner of the present invention preferably includes a colorant in an amount of from 6 to 12% by weight. When less than 6% by weight, the toner adheres too much to produce images having good granularity and thin line reproducibility. When greater than 12% by weight, chargeability of the toner becomes unstable or thermal properties thereof are affected, possibly resulting in fixability.

The colorant in the red toner of the present invention preferably includes an achromatic fluorescent color material having a chroma less than 3 or a fluorescent color material having a hue angle (H) of from 80 to 110° in L*a*b* color system.

The fluorescent color material influences less on the color properties of the red color material, and the color tone thereof when irradiated with black light looks the same as red under natural light. An image formed with a red toner including the fluorescent color material and an image formed with a red toner not including the fluorescent color material have the same color tone under a typical irradiation conditions. However, they are different in color tone under specific irradiation conditions. Even when the red toner is used in a confidential document, the red color can be recognized as a red color under black light. Further, even when a red image such as a stamp is falsified, falsification prevention can be expected because the falsification can be found with black light. The specific light is not limited to black light, and may be UV light. The black light is not particularly limited, and MODEL UVL-56 from UVP, LLC can be used.

Specific examples of the achromatic fluorescent color material having a chroma less than 3 include CARTAX from Clariant, 1057-YD from BASF Japan Ltd., etc.

Specific examples of the fluorescent color material having a hue angle (H) of from 80 to 110° include C. I. Pigment Yellow 101.

When the fluorescent color material is included in a red toner, a ratio of the total weight of the compound having a diketopyrrolopyrrole structure and the compound having a perylene structure to the total weight of the fluorescent color material is preferably from 4/1 to 2/1. When less than 4/1, the fluorescent intensity is insufficient. When greater than 2/1, the red color may become muddy or change in color tone.

Besides the red, process color toners, i.e., black, cyan, magenta and yellow toners, and special color toners such as white, green, blue, and metallic toners are combined.

Colorant used in these toners are not particularly limited, and conventional colorants can be used.

Carbon black alone or carbon black mixed with copper phthalocyanine such that color tone and brightness are adjusted is preferably used to form a black toner.

Copper phthalocyanine, i.e., C.I. Pigment Blue 15:3 or C.I. Pigment Blue 15:3 mixed with aluminum phthalocyanine is preferably used to form a cyan toner.

C.I. Pigment Red 53:1, C.I. Pigment Red 81, C.I. Pigment Red 122 and C.I. Pigment Red 269 are used alone or in combination to form a magenta toner.

C.I. Pigment Yellow 74, C.I. Pigment Yellow 155, C.I. Pigment Yellow 180, C.I. Pigment Yellow 185 are used alone or in combination to form a yellow toner. It is preferable that C.I. Pigment Yellow 185 is used alone or mixed with C.I. Pigment Yellow 74 in terms of chroma and preservability.

Titanium dioxide, the surface of which is treated with silicon, zirconia, aluminum or polyol is used as a white pigment.

C.I. Pigment Green 7 is used as a green toner, but safety needs to be considered.

C.I. Pigment Blue 15:1, C.I. Pigment Violet 23, etc. are used to form a blue toner.

### <Binder Resin>

The binder resins are not particularly limited, and conventionally-used resins can be used alone or in combination. The binder resin preferably includes a gel component insoluble in the solvent in an amount less than 0.5%. A fixed image has low glossiness and deteriorates in color reproducibility with the gel component. In addition, the resin composition can control the shape of a toner, and locations of a wax and a pigment therein.

Specific examples of the resins include vinyl polymers including styrene monomers, acrylic monomers or methacrylic monomers, or copolymers including two or more of the monomers; polyester polymers; a polyol resin; a phenol resin; a silicone resin; a polyurethane resin; a polyamide resin; a furan resin; an epoxy resin; a xylene resin; a terpene resin; a coumarone-indene resin; a polycarbonate resin; a petroleum resin; etc.

Among these, polyester polymers are preferably used for toner materials.

Specific examples of monomers forming the polyester polymers include dihydric alcohols, and they are preferably used together with alcohols having 3 or more valences to crosslink polyester resins.

Specific examples of the dihydric alcohols include diols such as ethyleneglycol, propyleneglycol, 1,3-butanediol, 1,4-butanediol, 2,3-butanediol, 1,4-butenediol, diethyleneglycol, triethyleneglycol, 1,5-pentanediol, 1,6-hexanediol, neopentylglycol, 2-ethyl-1,3-hexanediol, and diols formed by polymerizing hydrogenated bisphenol A or bisphenol A with cyclic ethers such as an ethylene oxide and a propylene oxide, etc.

Specific examples of polyalcohol having 3 or more valences include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxybenzene, etc.

Specific examples of acids forming the polyester polymers include benzene dicarboxylic acids or their anhydrides such as a phthalic acid, an isophthalic acid and a terephthalic acid; alkyl dicarboxylic acids or their anhydrides such as a succinic acid, an adipic acid, a sebacic acid and an azelaic acid; unsaturated diacids such as a maleic acid, a citraconic acid, an itaconic acid, an alkenylsuccinic acid, a fumaric acid and a mesaconic acid; and unsaturated diacid anhydrides such as a maleic acid anhydride, a citraconic acid anhydride, an itaconic acid anhydride and an alkenylsuccinic acid anhydride; etc.

Specific examples of polycarboxylic acids having 3 or more valences include a trimellitic acid, a pyromellitic acid, a 1,2,4-benzenetricarboxylic acid, a 1,2,5-benzenetricarboxylic acid, a 2,5,7-naphthalenetricarboxylic acid, a 1,2,4-naphthalenetricarboxylic acid, a 1,2,4-butanetricarboxylic acid, a 1,2,5-hexanetricarboxylic acid, a 1,3-dicarboxyl-2-methyl-methylenecarboxypropane, tetra(methylenecarboxyl)methane, 1,2,7,8-octantetracarboxylic acids, empol trimer or their anhydrides, or those partially replaced with lower alkyl esters, etc.

When the binder resin is selected from polyester resins, the binder resin preferably includes elements soluble with tetrahydrofuran (THF), having a weight-average molecular weight of from 8.0×10³ to 5.0×10⁴ in a molecular weight distribution by GPC thereof in terms of the fixability, offset resistance and storage stability of the resultant toner. When less than 8.0×10³, the residual solvent can be reduced but the offset resistance and storage stability of the resultant toner deteriorate. When greater than 5.0×10⁴, it is difficult to make the residual solvent value not greater than 200 ppm.

When the binder resin is selected from polyester resins, the binder resin preferably has an acid value of from 0.1 to 100 mg KOH/g, more preferably from 5 to 70 mg KOH/g, and much more preferably from 10 to 50 mg KOH/g.

In the vinyl polymers and/or polyester resins, resins including monomers reactable therewith can be used.

Specific examples of the monomers forming the polyester resin, reactable with the vinyl polymer include unsaturated dicarboxylic acids or their anhydrides such as a phthalic acid, a maleic acid, a citraconic acid and an itaconic acid.

Specific examples of the monomers forming the vinyl polymer include monomers having a carboxyl group or a hydroxy group, and an acrylic acid or ester methacrylates.

When the polyester polymer, vinyl polymer and other binder resins are used together, the united resins preferably includes resins having an acid value of from 0.1 to 50 mgKOH/g in an amount of 60% by weight.

The binder resin and compositions including the binder resin of the toner preferably has a glass transition temperature of from 35 to 80° C., and more preferably from 40 to 75° C. in terms of the storage stability of the resultant toner. When lower than 35° C., the resultant toner is likely to deteriorate in an environment of high temperature, and have offset problems when fixed. When higher than 80° C., the fixability thereof occasionally deteriorates.

Specific examples of the styrene monomers include styrenes or their derivatives such as styrene, o-methylstyrene, m-methylstyrene, p-methylstyrene, p-phenylstyrene, p-ethylstyrene, 2,4-dimethylstyrene, p-n-butylstyrene, p-tert-butylstyrene, p-n-hexylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dochlorostyrne, m-nitrostyrene, o-nitrostyrene and p-nitrostyrene.

Specific examples of the acrylic monomers include an acrylic acid or their esters such as methylacrylate, ethylacrylate, n-butylacrylate, isobutylacrylate, n-octylacrylate, n-dodecylacrylate, 2-ethylhexylacrylate, stearylacrylate, 2-chloroethylacrylate and phenylacrylate.

Specific examples of the methacrylic monomers include a methacrylic acid or their esters such as a methacrylic acid, methylmethacrylate, ethylmethacrylate, propylmethacrylate, n-butylmethacrylate, isobutylmethacrylate, n-octylmethacrylate, n-dodecylmethacrylate, 2-ethylhexylmethacrylate, stearylmethacrylate, phenylmethacrylate, dimethylaminoethylmethacrylate and diethylaminoethylmethacrylate.

Specific examples of other monomers forming the vinyl polymers or copolymers include the following materials (1) to (18):

(1) monoolefins such as ethylene, propylene, butylene and isobutylene; (2) polyenes such as butadiene and isoprene; (3) halogenated vinyls such as vinylchloride, vinylidenechloride, vinylbromide and vinylfluoride; (4) vinyl esters such as vinylacetate, vinylpropionate and vinylbenzoate; (5) vinylethers such as vinylmethylether, vinylethylether and vinylisobutylether; (6) vinylketones such as vinylmethylketone, vinylhexylketone and methyl isopropenylketone; (7) N-vinyl compounds such as N-vinylpyrrole, N-vinylcarbazole, N-vinylindole and N-vinylpyrrolidone; (8) vinylnaphthalenes; (9) acrylic acid or methacrylic acid derivatives such as acrylonitrile, methacrylonitrile and acrylamide; (10) unsaturated diacids such as a maleic acid, a citraconic acid, an itaconic acid, an alkenylsuccinic acid, a fumaric acid and a mesaconic acid; (11) unsaturated diacid anhydrides such as a maleic acid anhydride, a citraconic acid anhydride, an itaconic acid anhydride and an alkenylsuccinic acid anhydride; (12) monoesters of unsaturated diacids such as monomethylester maleate, monoethylester maleate, monobutylester maleate, monomethylester citraconate, monoethylester citraconate, monobutylester citraconate, monomethylester itaconate, monomethylester alkenylsuccinate, monomethylester fumarate and monomethylester mesaconate; (13) esters of unsaturated diacids such as a dimethyl maleic acid and a dimethyl fumaric acid; (14) α, β-unsaturated acids such as a crotonic acid and a cinnamic acid; (15) α, β-unsaturated acid anhydrides such as crotonic acid anhydride and a cinnamic acid anhydride; (16) monomers having a carboxyl group, such as anhydrides of the α, β-unsaturated acids and lower fatty acids, an alkenylmalonic acid, alkenylglutaric acid alkenyladipic acid, their anhydrides and monoesters; (17) hydroxyalkylester acrylates or methacrylates such as 2-hydroxyethylacrylate, 2-hydroxyethylmethacrylate and 2-hydroxypropylmethacrylate; and (18) monomers having a hydroxy group such as 4-(1-hydroxy-1-methylbutyl)styrene and 4-(1-hydroxy-1-methylhexyl)styrene.

The vinyl polymer or copolymer of the binder resin may have a crosslinked structure formed by a crosslinker having 2 or more vinyl groups. Specific examples of the crosslinker include aromatic divinyl compounds such as divinylbenzene and divinylnaphthalene. Besides, diacrylate compounds bonded with an alkyl chain, diacrylate compounds bonded with an alkyl chain including an ester bond, polyester diacrylates can also be used.

Specific examples of the diacrylate compounds bonded with an alkyl chain include ethyleneglycoldiacrylate, 1,3-butyleneglycoldiacrylate, 1,4-butanedioldiacrylate, 1,5-pentanedioldiacrylate, 1,6-hexanedildiacrylate, neopentylglycoldiacrylate or their dimethacrylates, etc.

Specific examples of diacrylate compounds bonded with an alkyl chain including an ester bond include as diethyleneglycoldiacrylate, triethyleneglycoldiacrylate, tetraethyleneglycoldiacrylate, polyethyleneglycoldiacrylate#400, polyethyleneglycoldiacrylate#600, dipropyleneglycoldiacrylate or their dimethacrylates. Besides, diacrylate or dimethacrylate compounds bonded with a chain including an aromatic group and an ether bond can also be used.

The polyester diacrylates include a product named MANDA from NIPPON KAYAKU CO., LTD.

Specific examples of a multifunctional crosslinker include pentaerythritoltriacrylate, trimethylolethanetriacrylate, trimethylolpropanetriacrylate, tetramethylolmethanetetraacrylate, oligoesteracrylate and their methacrylates, triallylcyanurate and triallyltrimellitate.

The toner preferably includes the crosslinker in an amount of 0.001 to 10 parts by weight, more preferably from 0.03 to 5 parts by weight based on total weight of the monomer.

Among these crosslinking monomers, the aromatic divinyl compounds, particularly the divinylbenzene and the diacrylate compounds bonded with a bonding chain including an aromatic group and an ether bond are preferably used in terms of the fixability and offset resistance of the resultant toner. Further, styrene copolymers and styrene-acrylic copolymers are more preferably used.

Specific examples of polymerization initiators used for preparing the vinyl polymer or copolymer include azo polymerization initiators such as 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobisisobutylate, 1, l′-azobis(cyclohexanecarbonitrile), 2-(carbamoylazo)-isobutyronitrile, 2,2′-azobis(2,4,4-trimethylpentane),

2-phenylazo-2′,4′-fimethyl-4′-methoxyvaleronitrile and 2,2′-azobis(2-methylpropane); ketone peroxides such as methyl ethyl ketone peroxide, acetylacetone peroxide and cyclohexanone peroxide; 2,2-bis(tert-butylperoxy)butane; tert-butylhydroperoxide; cumenehydroperoxide; 1,1,3,3-tetramethylbutylhydroperoxide; di-tert-butylperoxide; tert-butylcumylperoxide; di-cumylperoxide; α-(tert-butylperoxy)isopropylbenzene; isobutylperoxide; octanoylperoxide; decanoylperoxide; lauroylperoxide; 3,5,5-trimethylhexanoylperoxide; benzoylperoxide; m-tolylperoxide; di-isopropylperoxydi carbonate; di-2-ethylhexylperoxydicarbonate; di-n-propylperoxydicarbonate; di-2-ethoxyethylperoxycarbonate; di-ethoxyisopropylperoxydicarbonate; di(3-meth1-3-methoxybutyl)peroxycarbonate; acetylcyclohexylsulfonylperoxide; tert-butylperoxyacetate; tert-butylperoxyisobutylate; tert-butylperoxy-2-ethylhexalate; tert-butylperoxylaurate; tert-butyl-oxybenzoate; tert-butylperoxyisopropylcarbonate; di-tert-butylperoxyisophthalate; tert-butylperoxyallylcarbonate; isoamylperoxy-2-ethylhexanoate; di-tert-butylperoxyhexahydroterephthalate; tert-butylperoxyazelate; etc.

When the binder resin is selected from styrene-acrylic resins, the binder resin preferably includes elements soluble with tetrahydrofuran (THF), having a weight-average molecular weight of from 8.0×10³ to 5.0×10⁴ in a molecular weight distribution by GPC thereof in terms of the fixability, offset resistance and storage stability of the resultant toner. When less than 8.0×10³, the residual solvent can be reduced but the offset resistance and storage stability of the resultant toner deteriorate. When greater than 5.0×10⁴, it is difficult to make the residual solvent value not greater than 200 ppm.

When the binder resin is selected from vinyl polymers such as styrene-acrylic resins, the binder resin preferably has an acid value of from 0.1 to 100 mg KOH/g, more preferably from 0.1 to 70 mg KOH/g, and much more preferably from 0.1 to 50 mg KOH/g.

The toner of the present may be a toner prepared by dispersing an oil phase including an organic solvent, and a binder resin precursor and a colorant dissolved or dispersed therein in an aqueous medium to prepare an O/W dispersion, and removing the organic solvent therefrom.

The binder resin precursor is preferably formed of a modified polyester resin, and includes a polyester prepolymer modified by isocyanate and epoxy. This has an elongation reaction with a compound having an active hydrogen group such as amines to improve release width (a difference between the fixable minimum temperature and the hot offset occurrence temperature).

The polyester prepolymer can be synthesized by reacting known isocyanating agents or epoxidizers with a base polyester resin.

Specific examples of the isocyanating agents include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α, α, α′, α′-tetramethylxylylenediisocyanate; isocyanurate; the above-mentioned polyisocyanate blocked with phenol derivatives, oxime and caprolactam; and their combinations.

Specific examples of the epoxidizers include epichlorohydrine.

The isocyanating agent is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates.

The content of the isocyanating agent in the polyester prepolymer is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. When greater than 40% by weight, low-temperature fixability of the resultant toner deteriorates.

The number of the isocyanate group included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the urea-modified polyester decreases and hot offset resistance of the resultant toner deteriorates.

The binder resin precursor preferably has a weight-average molecular weight of from 1×10⁴ to 3×10⁵.

Specific examples of compounds elongating or crosslinking with the binder resin precursor include a compound having an active hydrogen group such as amines.

Specific examples of the amines include diamines, polyamines having three or more amino groups, amino alcohols, amino mercaptans, amino acids and blocked amines in which the amines mentioned above are blocked.

Specific examples of the diamines include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoronediamine); aliphatic diamines (e.g., ethylene diamine, tetramethylene diamine and hexamethylene diamine); etc.

Specific examples of the polyamines having three or more amino groups include diethylene triamine, triethylene tetramine.

Specific examples of the amino alcohols include ethanol amine and hydroxyethyl aniline.

Specific examples of the amino mercaptan include aminoethyl mercaptan and aminopropyl mercaptan.

Specific examples of the amino acids include amino propionic acid and amino caproic acid. Specific examples of the blocked amines include ketimine compounds which are prepared by reacting one of the amines mentioned above with a ketone such as acetone, methyl ethyl ketone and methyl isobutyl ketone; oxazoline compounds, etc.

Among these compounds, diamines and mixtures in which a diamine is mixed with a small amount of a polyamine are preferably used.

In the present invention, an amorphous unmodified polyester resin can be used as the binder resin precursor.

It is preferable that the modified polyester resin prepared by crosslinking and/or elongating the binder resin precursor formed of the modified polyester resins and the unmodified polyester resin are at least partially compatible, which improves low-temperature fixability and hot offset resistance of the resultant toner. Therefore, polyols and polycarboxylic acids forming the modified polyester resin and the unmodified polyester resin preferably have similar compositions.

The crystalline polyester resin can be dispersed and included in the toner of the present invention. Having crystallinity, the crystalline polyester resin quickly decreases viscosity around an endothermic peak temperature. Namely, just before a melt starting temperature, the crystalline polyester resin has good thermostability, and quickly decreases viscosity (has sharp meltability) at the melt starting temperature and fixed. Therefore, the crystalline polyester resin forms a toner having both good thermostability and low-temperature fixability.

A toner including the crystalline polyester resin having a sharp endothermic curve and an endothermic peak at from 60 to 100° C., preferably from 65 to 75° C. has better low-temperature fixability and thermostability.

Specific examples of the crystalline polyester resins include those obtained by synthesizing alcoholic components such as saturated aliphatic diol compounds having 2 to 12 carbon atoms, particularly 1,4-butanediol, 1,6-hexanediol, 1,8-octanediol, 1,10-decanediol, 1,12-dodecanediol and their derivatives; and acidic components such as saturated dicarboxylic acids, particularly, fumaric acid, 1,4-butanediacid, 1,6-hexanediacid, 1,8-ocatnediacid, 1,10-decanediacid, 1,12-dodecanediacid and their derivatives.

Among these alcoholic components and acidic components, in terms of make a difference between an endothermic peak temperature and an endothermic shoulder temperature smaller, the crystalline polyester resin is preferably synthesized with only one of alcoholic components of 1,4-butanediol, 1,6-hexanediol, 1,8-octanediol, 1,10-decanediol, 1,12-dodecanediol and one of dicarboxylic acids of fumaric acid, 1,4-butanediacid, 1,6-hexanediacid, 1,8-ocatnediacid, 1,10-decanediacid, 1,12-dodecanediacid.

The toner of the present invention may include an organic low-molecular-weight material besides the colorant and the binder resin precursor to have various capabilities.

Specific examples of the organic low-molecular-weight material include aromatic acid esters such as a fatty acid ester and a phthalic acid; phosphate ester; maleic acid ester; fumaric acid ester; itaconic acid ester; other esters; ketones such as benzyl, benzoin compounds and benzoyl compounds; hindered phenol compounds; benzotriazole compounds; aromatic sulfonamide compounds; fatty amide compounds; long-chain alcohols; long-chain dialcohols; long-chain carboxylic acids; long-chain dicarboxylic acids; etc.

These specifically include dimethylfumarate, monoethylfumarate, monobutylfumarate, monomethylitaconate, diphenyladipate, dibenzylterephthalate, dibenzylisophthalate, benzyl, benzoinisopropylether, 4-benzoylbiphenyl, 4-benzoyldiphenylether, 2-benzoylnaphthalene, dibenzoylmethane, 4-biphenylcarboxylic acid, stearyl amide stearate, oleyl amide stearate, stearic amide oleate, octadecanol, n-octylalcohol, tetracosanoic acid, eicosanoic acid, stearic acid, lauric acid, nonadecanoic acid, palmitic acid, hydroxy octanoic acid, docosanoic acid, the compounds disclosed in Japanese published unexamined application No. JP-2002-105414-A, having the formulae (1) to (17), etc.

Further, natural waxes, e.g., plant waxes such as carnauba wax, cotton wax, Japan wax and rice wax; animal waxes such as bees wax and lanolin; mineral waxes such as ozokerite and ceresin; petroleum waxes such as paraffin, microcrystalline and petrolatum can also be included in the toner constituents.

In addition to the natural waxes, synthetic hydrocarbon waxes such as Fischer-Tropsch wax and polyethylene wax and synthetic waxes such as of esters, ketones, and ethers are exemplified.

Further, fatty acid amides such as hydroxy stearic acid amide, stearic acid amide, acid phthalic anhydride amide and chlorinated hydrocarbon; homopolymers of polyacrylate which are low-molecular-weight crystalline polymeric resins such as poly-n-stearylmethacrylate and poly-n-laurylmethacrylate or copolymer of the polyacrylate such as n-stearylacrylate-ethylmethacrylate copolymer; crystalline polymers having long side-chain alkyl groups; etc. can also be used.

These can be used alone or in combination.

When a resin and the organic low-molecular-weight material are compatible at a temperature not lower than a melting point of the organic low-molecular-weight material, the organic low-molecular-weight material works as a plasticizer. Namely, the organic low-molecular-weight material improves a softening point of the resin such that the resultant toner has good low-temperature fixability. In this case, the organic low-molecular-weight material preferably has a melting point not higher than 120° C., and more preferably not higher than 80° C. When higher than 120° C., low-temperature fixability of the resultant toner is not improved.

When the resin and the organic low-molecular-weight material are not compatible, the organic low-molecular-weight material works as a release agent. In this case, the organic low-molecular-weight material preferably has a melting point not higher than 100° C., and more preferably not higher than 80° C. When higher than 100° C., cold offset is likely to occur when toner images are fixed.

The organic low-molecular-weight material preferably has a melting viscosity of from 5 to 1,000 cps, and more preferably from 10 to 100 cps at a temperature higher than a melting point thereof by 10° C. When less than 5 cps, the releasability of the resultant toner occasionally deteriorates. When greater than 1,000 cps, it is likely that the hot offset resistance and low-temperature fixability of the resultant toner are not improved.

### (Developer)

The developer of the present invention can be used as a one-component developer or in a two-component developer including the red toner of the present invention.

When used in the two-component developer with a magnetic carrier, the developer preferably includes the toner in an amount of from 1 to 10 parts by weight per 100 parts by weight of a carrier.

Suitable magnetic carriers include known carrier materials such as iron powders, ferrite powders, magnetite powders, magnetic resin carriers, which have a particle diameter of from about 20 to 200 μm.

The surface of the carrier may be coated by a resin. Specific examples of such resins to be coated on the carriers include amino resins such as urea-formaldehyde resins, melamine resins, benzoguanamine resins, urea resins, and polyamide resins, and epoxy resins. In addition, vinyl or vinylidene resins such as acrylic resins, polymethylmethacrylate resins, polyacrylonitirile resins, polyvinyl acetate resins, polyvinyl alcohol resins, polyvinyl butyral resins, polystyrene resins, styrene-acrylic copolymers, halogenated olefin resins such as polyvinyl chloride resins, polyester resins such as polyethyleneterephthalate resins and polybutyleneterephthalate resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins.

An electroconductive powder may be included in the toner when necessary. Specific examples of such electroconductive powders include metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The red toner of the present invention can also be used as a one-component magnetic developer or a one-component non-magnetic developer without using a carrier.

### (Image Forming Apparatus)

Next, the image forming apparatus of the present invention is explained.

### <First Embodiment of Image Forming Apparatus>

An image forming apparatus of this embodiment includes at least an electrostatic latent image bearer, a charger charging the surface of the electrostatic latent image bearer, an irradiator irradiating the surface thereof to form an electrostatic latent image thereon, an image developer developing the electrostatic latent image with a developer including a toner to form a toner image on the electrostatic latent image bearer, a transferer transferring the toner image onto a transfer material and a fixer fixing the toner image thereon. The number of the image developer is 5 for a black toner, a cyan toner, a magenta toner, a yellow toner and the red toner.

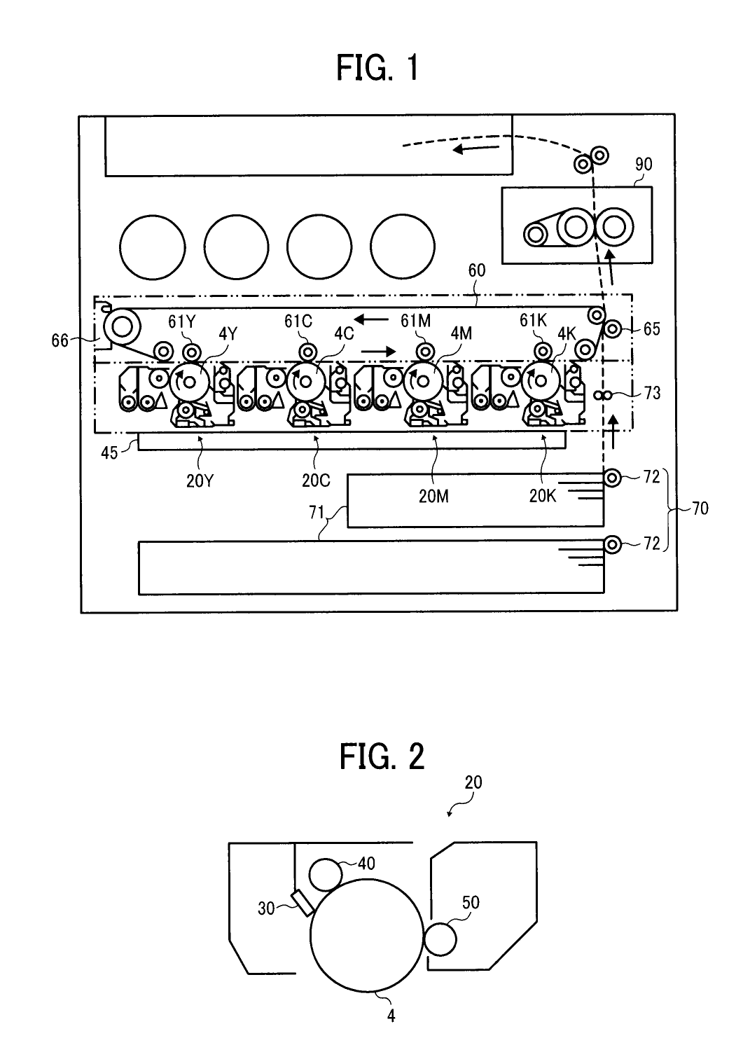

FIG. 1 is a schematic view illustrating an embodiment of the image forming apparatus of the present invention. In FIG. 1, a red toner image former is omitted. The image forming apparatus in FIG. 1 is so-called a tandem image forming apparatus in which toner image formers 20Y, C, M, K and A for yellow, cyan, magenta, black and red are located in parallel and overlap each of color toner images of yellow (Y), cyan (C), magenta (M), black (K) and red (A) formed by each of the toner image formers to form a full-color image. The lines of the toner image formers are not particularly limited.

The toner image formers 20Y, C, M, K and A include rotatable photoconductor drums 4Y, C, M, K and A as image bearers, respectively. An irradiator 45 irradiates each of the photoconductor drums 4Y, C, M, K and A with a laser beam or LED light, based on each color image information to form a latent image.

An intermediate transfer belt 60 as an intermediate transferer is located opposite to each of the toner image formers 20Y, C, M, K and A such that the surface thereof is movable. Each of first transfer rollers 61Y, C, M, K and A transferring each color toner image formed on each of the photoconductor drums 4Y, C, M, K and A onto the intermediate transfer belt 60 is located at a position opposite to each of the photoconductor drums 4Y, C, M, K and A through the intermediate transfer belt 60.

Each of the first transfer rollers 61Y, C, M, K and A sequentially transfers each of the color toner images formed by each of the toner image formers 20Y, C, M, K and A onto the intermediate transfer belt 60 and overlaps each of them thereon to form a full-color image.

A second transferer 65 transferring the toner image on the intermediate transfer belt 60 onto a transfer paper at a time is located at downstream side of the first transfer rollers 61Y, C, M, K and A in the moving direction of the surface of the intermediate transfer belt 60. Further, a cleaner 66 removing a toner remaining on the surface of the intermediate transfer belt 60 is located at downstream side of the second transferer 65.

A paper feeder 70 including a paper feed cassette 71, a paper feed roller 72, etc. is located is located at the bottom of the image forming apparatus to feed a transfer paper to a registration roller 73. The registration roller 73 feeds a transfer paper between the intermediate transfer belt 60 and the second transferer 65, synchronizing with the toner image formation. The full-color toner image on the intermediate transfer belt 60 is transferred onto a transfer paper by the second transferer 65, fixed by a fixer 90 thereon, and discharged from the apparatus.

Next, each of the toner image formers 20Y, C, M, K and A is explained. Since each of the toner image formers 20Y, C, M, K and A has almost the same configuration and operation except for the color of a toner contained therein, Y, C, M, K and A are omitted hereafter. FIG. 2 is a schematic view illustrating a main part in the embodiment of the image forming apparatus of the present invention.

Around the photoconductor drum 4 in the toner image former 20, each of means executing electrophotographic process such as a charger 40, an image developer 50 and a cleaner 30 is located to form each color toner image on the photoconductor drum 4 by known operation. The toner image former 20 may be an integrally-formed process cartridge detachable from an image forming apparatus.

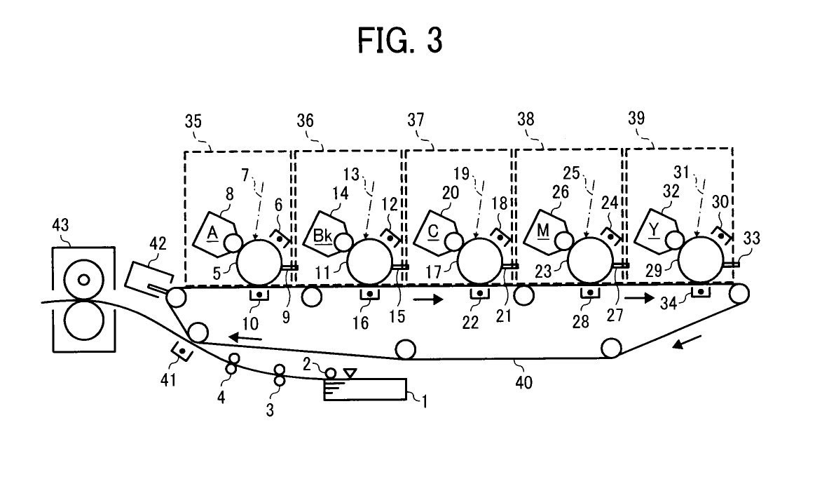

FIG. 3 is a schematic view illustrating another main part in the embodiment of the image forming apparatus of the present invention including 5 image developers.

The image forming apparatus includes photoconductors 5, 11, 17, 23 and 29, and chargers 6, 12, 18, 24 and 30, image developers 8, 14, 20, 26 and 32, transferers 10, 16, 22, 28 and 34, and cleaners 9, 15, 21, 27 and 33 around the photoconductors 5, 11, 17, 23 and 29. Light 7, 13, 19, 25 and 31 is irradiated to the photoconductor

Each of developing units includes the photoconductor, the charger, the image developer and the cleaner. The developing unit 35 forms an image with a red toner, the developing unit 36 forms an image with a black toner, developing unit 37 forms an image with a cyan toner, the developing unit 38 forms an image with a magenta toner, and the developing unit 39 forms an image with a yellow toner. Each of the toner images is transferred onto an intermediate transfer belt 40 to form an image, and the image formed thereon is transferred onto a recording medium by a transferer 41 and fixed by a fixer 43 thereon.

It is preferable that the cyan toner includes C. I. Pigment Blue 15:3, the magenta toner includes C. I. Pigment Red 122, the yellow toner includes C. I. Pigment Yellow 185, and the black toner includes carbon black. Thus, an image forming apparatus having good color reproducibility can be provided.

In the present invention, the transfer material is also called a recording medium, a recording material, a transfer paper, a recording paper, etc., but is not particularly limited and known ones can be used.

### <Second Embodiment of Image Forming Apparatus>

An image forming apparatus of this embodiment includes at least an electrostatic latent image bearer, a charger charging the surface of the electrostatic latent image bearer, an irradiator irradiating the surface thereof to form an electrostatic latent image thereon, an image developer developing the electrostatic latent image with a developer including a toner to form a toner image on the electrostatic latent image bearer, a transferer transferring the toner image onto a transfer material and a fixer fixing the toner image thereon. The number of the image developer is 2, and one includes a black toner and the other includes the red toner.

Hereinafter, details are explained and explanations on matters common with the first embodiment are omitted.

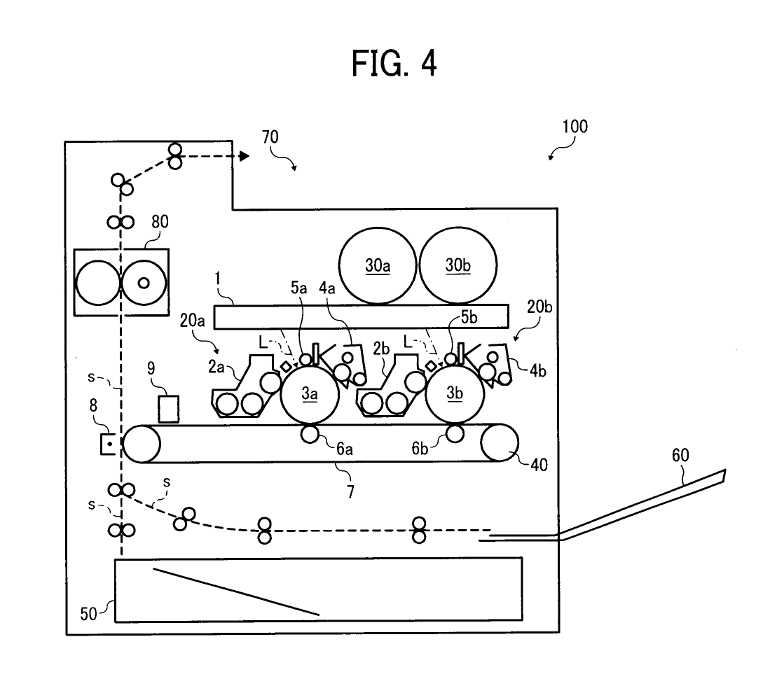

FIG. 4 is a schematic view illustrating another embodiment of the image forming apparatus of the present invention. In this embodiment, a printer is shown as an image forming apparatus. The image forming apparatus may be a copier, a facsimile or their combination machine capable of forming a multicolor or monochrome image on a transfer material according to not image data transmitted from outside but also image data read from an original by a scanner.

The image forming apparatus 100 in FIG. 4 is a double color printer capable of forming a first color image, a second color image and their mixed possible color image on a sheet-shaped transfer (recording) paper according to image date transmitted from outside.

The image forming apparatus 100 includes a first color toner image former 20a and a second color toner image former 20b. The first color toner image former 20a includes a black toner and the second color toner image former 20b includes a red toner, or may be vice versa.

The first color toner image former 20a includes a photoconductor drum 3a, and a charger 5a charging the surface of the photoconductor drum 3a, an irradiator 1 irradiating light L to the surface thereof to form an electrostatic latent image on the surface thereof, an image developer 2a developing the electrostatic latent image with a first color toner to form a first color toner image, a cleaner 4a removing a residual toner remaining on the surface of the photoconductor drum 3a, and a discharge lamp 7a around the photoconductor drum 3a. The image developer 2a is provided with the first color toner from a provider 30a located above the toner image former 20a.

Similarly, the first color toner image former 20b includes a photoconductor drum 3b as well, and a charger 5b charging the surface of the photoconductor drum 3a, an irradiator 1 irradiating light L to the surface thereof to form an electrostatic latent image on the surface thereof, an image developer 2b developing the electrostatic latent image with a first color toner to form a first color toner image, a cleaner 4b removing a residual toner remaining on the surface of the photoconductor drum 3b, and a discharge lamp 7b around the photoconductor drum 3b. The image developer 2b is provided with the first color toner from a provider 30b located above the toner image former 20b.

The irradiator 1 forming an electrostatic latent image on the surface of each of the photoconductor drums 3a and 3b is located above each of the toner image formers 20a and 20b. An intermediate transfer unit (transferer) 40 transferring a toner image on each of the photoconductor drums 3a and 3b onto a transfer paper is located below each of the toner image formers 20a and 20b.

The intermediate transfer unit 40 includes an intermediate transferer 7 a toner image formed by each of the toner image formers 20a and 20b is transferred to, each of first transfer rollers 6a and 6b located inside of the intermediate transferer 7, transferring a toner image on the surface of each of the photoconductor drums 3a and 3b onto the intermediate transferer 7, and a second transfer roller 11 transferring the toner image onto a transfer paper therefrom. The intermediate transferer 7 is preferably an endless belt.

The image forming apparatus 100 includes a paper feed tray 50 containing transfer papers at the bottom and a manual feed tray 60 on one side thereof.

The image forming apparatus 100 includes a fixer 80 fixing a toner image on a transfer paper at the upper part thereof and a paper discharge tray 70 at the top.

There is a sheet conveyance route S through which a transfer material fed from the paper feed tray 50 or the manual feed tray 60 is conveyed to an intermediate transfer belt unit 8 and the fixer 80.

In each of the toner image formers 20a and 20b, the surface of each of the photoconductor drums 3a and 3b charged by each of the chargers 5a and 5b is irradiated by the irradiator 1 to form an electrostatic latent image on the surface of each of the photoconductor drums 3a and 3b.

The irradiator 1 irradiates the photoconductor drum 3a for a first color according to image data including the first color component and the photoconductor drum 2a for a second color according to image data including the second color component. The image developers 2a and 2b provides the first and the second color toners to the electrostatic latent image, respectively to form a first color toner image and a second color toner image on each of the photoconductor drums 3a and 3b.

The first color toner image and the second color toner image formed on each of the photoconductor drums 3a and 3b are transferred onto the intermediate transferer 7 while overlapped by each of the first transfer rollers 6a and 6b in the intermediate transfer unit 40. The toner image transferred onto the intermediate transferer 7 is transferred onto a transfer paper conveyed through the sheet conveyance route S. The transfer paper the toner image is transferred to passes the fixer 9 such that the toner image is fixed on the transfer paper, and then discharged on the paper discharge tray 70.

A scanner for feeding paper, sensor for image registration and a feed controller may be located on a conveyance route between the paper feed tray 50 or the manual feed tray 60 and the second transferer. The scanner reads an image written in a transfer paper and feeds back the data to form an image on the more precise position of the transfer paper.

### <Third Embodiment of Image Forming Apparatus>

An image forming apparatus of this embodiment includes at least an electrostatic latent image bearer, a charger charging the surface of the electrostatic latent image bearer, an irradiator irradiating the surface thereof to form an electrostatic latent image thereon, an image developer developing the electrostatic latent image with a developer including a toner to form a toner image on the electrostatic latent image bearer, a transferer transferring the toner image onto a transfer material and a fixer fixing the toner image thereon. The number of the image developer is 4, and 1, 2 or 3 of them includes a black toner or a red toner.

### Examples

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### (Preparation of Masterbatch)

### <Preparation of Red Masterbatch A>

One hundred (100) parts of C.I. Pigment Red 254 (IRGAZIN RED 3630 from BASF Japan, Ltd.), 400 parts of a polyester A (EXL-101 having a glass transition temperature (Tg) of 61° C. and a weight-average molecular weight (Mw) of 6,800 from Sanyo Chemical Industries, Ltd., mainly formed of an adduct of bisphenol A with ethylene oxide and a terephthalic acid,), and 30 parts of ion-exchanged water were fully mixed in a polyethylene bag to prepare a mixture. The mixture was kneaded twice in an open-roll kneader (Kneadex from Nippon Coke & Engineering Co., Ltd.) at 90° C. at feeding side and 50° C. at discharge side of front roll, 30° C. at feeding side and 20° C. at discharge side of back roll, at 35 rpm of front roll, 31 rpm of back roll, and with a gap 0.25 mm. The kneaded mixture was pulverized by a pulverizer from Hosokawa Micron Ltd. to prepare Red Masterbatch A.

### <Preparation of Red Masterbatch B>

The procedure for preparation of the Red Masterbatch A was repeated except for replacing C.I. Pigment Red 254 with C.I. Pigment Red 255 (IRGAZIN SCARLET L3550HD from BASF Japan, Ltd.) to prepare Red Masterbatch B.

### <Preparation of Red Masterbatch C>

The procedure for preparation of the Red Masterbatch A was repeated except for replacing C.I. Pigment Red 254 with C.I. Pigment Red 149 (PALIOGEN RED K3580 from BASF Japan, Ltd.) to prepare Red Masterbatch C.

### <Preparation of Red Masterbatch D>

The procedure for preparation of the Red Masterbatch A was repeated except for replacing C.I. Pigment Red 254 with C.I. Pigment Red 166 (CROMOPHTAL SCARLET RT from BASF Japan, Ltd.) to prepare Red Masterbatch D.

### <Preparation of Fluorescent Color Agent Masterbatch E>

The procedure for preparation of the Red Masterbatch A was repeated except for replacing C.I. Pigment Red 254 with C.I. Pigment Yellow 101 (LUMOGEN YELLOW S0795 from BASF Japan, Ltd.) to prepare Fluorescent Color Agent Masterbatch E.

### <Preparation of Fluorescent Color Agent Masterbatch F>

The procedure for preparation of the Red Masterbatch A was repeated except for replacing C.I. Pigment Red 254 with a stealth fluorescent color agent (1057-YD from BASF Japan, Ltd.) to prepare Fluorescent Color Agent Masterbatch F.

### <Preparation of Fluorescent Color Agent Masterbatch G>

The procedure for preparation of the Red Masterbatch A was repeated except for replacing C.I. Pigment Red 254 with a stealth fluorescent color agent (CARTAX from Clariant (Japan) K.K.) to prepare Fluorescent Color Agent Masterbatch G.

### (Preparation of Pulverization Toner)

Each of the master batches, polyester A, polyester B (RN-300 from Kao Corp.) and carnauba wax (WA-05 from CERARICA NODA Co., Ltd) were mixed according to a formulation in Table 1 to prepare a mixture. The mixture was kneaded twice in an open-roll kneader (Kneadex from Nippon Coke & Engineering Co., Ltd.) at 100° C. at feeding side and 60° C. at discharge side of front roll, 40° C. at feeding side and 30° C. at discharge side of back roll, at 35 rpm of front roll, 31 rpm of back roll, and with a gap 0.25 mm. The kneaded mixture was pulverized by a pulverizer from Hosokawa Micron Ltd., and further pulverized by a jet mill and classified to prepare a mother toner having a volume-average particle diameter (Dv) of 6.0 μm and a ratio (Dv/Dn) of the volume-average particle diameter (Dv) to a number-average particle diameter of 1.20.

Further, 1.5 parts of hydrophobized silica (HDK H2000 having a particle diameter of 10 nm from Wacker Chemical GmbH.) and 1.0 part of hydrophobized titania (MT-15OAI having a particle diameter of 15 μm from Tayca Corp.) were externally added by HENSCHEL mixer to 100 parts of each of the mother toners to prepare each of pulverization toners A to Q.

Compositions of toners A to Q are shown in Table 1.

TABLE 1

| | | Fluo- | | | |
|---|---|---|---|---|---|
| | | rescent | Low- | | |
| | Red | Material | Molecular- | Polymeric | |
| | Master- | Master- | Weight | Polyester or | |
| Toner | batch | batch | Polyester | Prepolymer | Wax |
| A | A 40 parts | None | Polyester A | Polyester B | Carnauba |
| | | | 40 parts | 15 parts | Wax 5 parts |
| B | B 40 parts | None | Polyester A | Polyester B | Carnauba |
| | | | 40 parts | 15 parts | Wax 5 parts |
| C | C 50 parts | None | Polyester A | Polyester B | Carnauba |
| | | | 30 parts | 15 parts | Wax 5 parts |
| D | D 40 parts | None | Polyester A | Polyester B | Carnauba |
| | | | 40 parts | 15 parts | Wax 5 parts |
| E | D 40 parts | E 20 parts | Polyester A | Polyester B | Carnauba |
| | | | 20 parts | 15 parts | Wax 5 parts |
| F | D 40 parts | F 15 parts | Polyester A | Polyester B | Carnauba |
| | | | 25 parts | 15 parts | Wax 5 parts |
| G | D 40 parts | G 15 parts | Polyester A | Polyester B | Carnauba |
| | | | 25 parts | 15 parts | Wax 5 parts |
| H | D 40 parts | E 10 parts | Polyester A | Polyester B | Carnauba |
| | | | 30 parts | 15 parts | Wax 5 parts |
| I | A 40 parts | E 20 parts | Polyester A | Polyester B | Carnauba |
| | | | 20 parts | 15 parts | Wax 5 parts |
| J | A 40 parts | F 15 parts | Polyester A | Polyester B | Carnauba |
| | | | 25 parts | 15 parts | Wax 5 parts |
| K | A 40 parts | G 15 parts | Polyester A | Polyester B | Carnauba |
| | | | 25 parts | 15 parts | Wax 5 parts |
| L | B 40 parts | E 20 parts | Polyester A | Polyester B | Carnauba |
| | | | 20 parts | 15 parts | Wax 5 parts |
| M | B 40 parts | F 15 parts | Polyester A | Polyester B | Carnauba |
| | | | 25 parts | 15 parts | Wax 5 parts |
| N | B 40 parts | G 15 parts | Polyester A | Polyester B | Carnauba |
| | | | 25 parts | 15 parts | Wax 5 parts |
| O | C 40 parts | E 20 parts | Polyester A | Polyester B | Carnauba |
| | | | 20 parts | 15 parts | Wax 5 parts |
| P | C 40 parts | F 15 parts | Polyester A | Polyester B | Carnauba |
| | | | 25 parts | 15 parts | Wax 5 parts |
| Q | C 40 parts | G 15 parts | Polyester A | Polyester B | Carnauba |
| | | | 25 parts | 15 parts | Wax 5 parts |

### (Preparation of Toner by Solution Suspension Method)

### <Preparation of Wax Dispersion A>

Next, a dispersion including a binder resin and a wax having the following composition was prepared.

One hundred (100) of polyester C (SREX-005L having a Tg of 58° C. and a Mw of 7.600 from Sanyo Chemical Industries, Ltd.), 90 parts of a paraffin wax (HPE-11) and 10 parts of a maleic-acid-modified paraffin wax (P-166) were stirred and dispersed in 300 parts of ethylacetate in a mixer having a stirring blade for 10 min, and further dispersed by DYNO-MILL for 8 hrs to prepare a [wax dispersion A].

### <Preparation of Toner Composition Liquid S>

Five hundred seventy (570) parts of polyester C, 80 parts of C. I. Pigment Red 149, 250 parts of the [wax dispersion A] and 600 parts of ethyl acetate were dissolved and dispersed in a mixer having a stirring blade to prepare a dispersion. The dispersion was further circulated and dispersed by a beads mill (Ultra Visco Mill from IMECS CO., LTD.) for 1 hr under the following conditions to prepare a [material solution dispersion S]:

liquid feeding speed of 1 kg/hr; peripheral disc speed of 6 m/sec; and filling zirconia beads having diameter of 0.5 mm for 80% by volume.

One hundred fifty (150) parts of the [material solution dispersion S] and 50 parts of prepolymer A (SREU-11, ethylacetate solution including a solid content of 50% from Sanyo Chemical Industries, Ltd.) were mixed in a mixer having a stirring blade to prepare a toner composition liquid S.

### <Preparation of Toner Composition Liquid T>

Five hundred seventy (570) parts of polyester C, 80 parts of C. I. Pigment Red 149, 40 parts of Pigment Yellow 101, 250 parts of the [wax dispersion A] and 600 parts of ethyl acetate were dissolved and dispersed in a mixer having a stirring blade to prepare a dispersion. The dispersion was further circulated and dispersed by a beads mill (Ultra Visco Mill from IMECS CO., LTD.) for 1 hr under the following conditions to prepare a [material solution dispersion T]:

liquid feeding speed of 1 kg/hr; peripheral disc speed of 6 m/sec; and filling zirconia beads having diameter of 0.5 mm for 80% by volume.

One hundred fifty (150) parts of the [material solution dispersion T] and 50 parts of prepolymer A (SREU-11, ethylacetate solution including a solid content of 50% from Sanyo Chemical Industries, Ltd.) were mixed in a mixer having a stirring blade to prepare a toner composition liquid S.

### <Preparation of Particulate Resin Dispersion>

Six hundred eighty three (683) parts of water, 11 parts of a sodium salt of an adduct of a sulfuric ester with ethyleneoxide methacrylate (ELEMINOL RS-30 from Sanyo Chemical Industries, Ltd.), 79 parts of styrene, 79 parts of methacrylate, 105 parts of butylacrylate, 13 parts of divinylbenzene and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of an aqueous solution of persulfate ammonium having a concentration of 1% were added thereto and the mixture was reacted at 75° C. for 5 hrs to prepare an aqueous dispersion (a particulate resin dispersion) of a vinyl resin (a copolymer of a sodium salt of an adduct of styrene-methacrylate-butylacrylate-sulfuric ester with ethyleneoxide methacrylate).

The [particulate resin dispersion] had a volume-average particle diameter of 105 nm when measured by LA-920. The [particulate resin dispersion] was partially dried to isolate a resin. The resin had a Tg of 95° C., a number-average molecular weight of 140,000 and weight-average molecular weight of 980,000.

### <Preparation of Aqueous Medium>

Three hundred and six (306) parts of ion-exchange water, 60 parts of the [particulate resin dispersion] and 4 parts of sodium dodecylbenzenesulfonate were mixed while stirred such that the solid contents were uniformly dissolved to prepare an [aqueous medium].

### <Preparation of Emulsion or Dispersion>

Two hundred (200) parts of the [aqueous medium] were placed in a container and stirred by T. K. Homomixer at 10,500 rpm, and 100 parts of the [toner composition liquid S] were added therein and mixed for 2 min, and dispersed at 4,500 rpm for a time needed to prepare an [emulsion or dispersion S] (an emulsified slurry) having a volume-average particle diameter (Dv) of 6.0 μm and Dv/Dn of 1.15±0.2.

The procedure for preparation of the [emulsion or dispersion S] was repeated except for replacing the [toner composition liquid S] with the [toner composition liquid T] to prepared an [emulsion or dispersion T] (an emulsified slurry).

### [Removal of Organic Solvent]

One hundred (100) parts of the [emulsion or dispersion S] were placed in a flask including a stirrer and a thermometer, and after a solvent was removed therefrom at 30° C. for 12 hrs while stirred at a peripheral speed of 20 m/min to prepare a [dispersion slurry S].

The procedure for preparation of the [dispersion slurry S] was repeated except for replacing the [emulsion or dispersion S] with the [emulsion or dispersion T] to prepare a [dispersion slurry T].

### <Washing & Drying>

After 100 parts of the [dispersion slurry was S] was filtered under reduced pressure, 100 parts of ion-exchange water were added to the filtered cake and mixed by T. K. Homomixer at 12,000 rpm for 10 min, and the mixture was filtered.

Three hundred (300) parts of ion-exchange water were added to the filtered cake and mixed by T. K. Homomixer at 12,000 rpm for 10 min, and the mixture was filtered. This operation was repeated again.

Twenty (20) parts of aqueous sodium hydroxide having a concentration of 10% by weight were added to the filtered cake and mixed by T. K. Homomixer at 12,000 rpm for 30 min, and the mixture was filtered under reduced pressure.

Three hundred (300) parts of ion-exchange water were added to the filtered cake and mixed by T. K. Homomixer at 12,000 rpm for 10 min, and the mixture was filtered.

Three hundred (300) parts of ion-exchange water were added to the filtered cake and mixed by T. K. Homomixer at 12,000 rpm for 10 min, and the mixture was filtered. This operation was repeated again.

Twenty (20) parts of hydrochloric acid having a concentration of 10% by weight were added to the filtered cake and mixed by T. K. Homomixer at 12,000 rpm for 30 min, and the mixture was filtered.

Three hundred (300) parts of ion-exchange water were added to the filtered cake and mixed by T. K. Homomixer at 12,000 rpm for 10 min, and the mixture was filtered. This operation was repeated again to prepare a final filtered cake.

The final filtered cake was dried by an air drier at 45° C. for 48 hrs, and sieved with a mesh having an opening of 75 μm to prepare mother toner particles S.

The procedure for preparation of the mother toner particles S was repeated except for replacing the [dispersion slurry S] with the [dispersion slurry T] to prepare mother toner particles T.

Further, 1.5 parts of hydrophobized silica (HDK H2000 having a particle diameter of 10 nm from Wacker Chemical GmbH.) and 1.0 part of hydrophobized titania (MT-15OAI having a particle diameter of 15 μm from Tayca Corp.) were externally added by HENSCHEL mixer to 100 parts of each of the mother toner particles to prepare toners S and T.

### [Preparation of Carrier]

A spherical particulate ferrite having a volume-average particle diameter of 35 μm as a core material was coated with a mixture of a silicone resin and a melamine resin as a coating material to prepare a carrier.

### [Preparation of Developer]

Each of the toners A to Q, S and T were mixed with the carrier to prepare a two-component developer.

### (Evaluation)

Each of the two-component developers was placed in a developing unit of Imagio Neo C350 from Ricoh company, Ltd., in which a toner adherence amount was controlled to produce images having suitable color properties, and a solid image was produced thereby on a POD gloss paper from Oji Paper Co., Ltd. The toner adherence amount was an amount of a toner adhering to a transfer paper, and controlled as shown in Table 2.

The color reproduction range was measured by a spectrodensitometer X-Rite 938 from X-Rite, Inc.

As a Comparative Example, in two units of Imagio Neo C350 from Ricoh company, Ltd., a yellow toner and a magenta toner of color toner set A (toner set for Color 1000 Press from Fuji Xerox Co., Ltd.) were placed, respectively, in which a toner adherence amount was controlled to produce images having preferable color properties. A second color red image obtained by overlapping the yellow toner solid image and the magenta toner solid image was produced (Comparative Example 1, Process Color YM1).

Further, the procedure for producing the second color red image was repeated except for replacing color toner set A with color toner set B (toner set for imagio MP C5002) to produce another second color red image (Comparative Example 2, Process Color YM2).

The adherence amount and the color properties of each of the toners are shown in Table 2.

MODEL UVL-56 having a wavelength of 365 nm from UVP, LLC was used as the black light. Black light was irradiated after an image was produced to visually observe the color.

TABLE 2
(1)

| | | Adherence | | | |
|---|---|---|---|---|---|
| | | Amount | | | |
| | | (mg/cm²) | L* | a* | b* |
| Example 1 | Toner A | 0.40 | 49.8 | 77.5 | 62.0 |
| Example 2 | Toner A | 0.60 | 47.6 | 78.0 | 74.5 |
| Example 3 | Toner B | 0.40 | 54.5 | 70.2 | 68.1 |
| Example 4 | Toner B | 0.60 | 52.0 | 71.6 | 76.7 |
| Example 5 | Toner C | 0.60 | 53.6 | 71.3 | 62.7 |
| Example 6 | Toner D | 0.40 | 48.2 | 77.1 | 60.6 |
| Example 7 | Toner E | 0.40 | 51.0 | 75.1 | 61.0 |
| Example 8 | Toner F | 0.40 | 48.0 | 76.8 | 61.2 |
| Example 9 | Toner G | 0.40 | 48.1 | 76.8 | 61.1 |
| Example 10 | Toner H | 0.40 | 49.2 | 76.4 | 60.8 |
| Example 11 | Toner I | 0.40 | 51.6 | 76.2 | 62.5 |
| Example 12 | Toner J | 0.40 | 49.6 | 77.4 | 62.1 |
| Example 13 | Toner K | 0.40 | 49.7 | 77.2 | 62.2 |
| Example 14 | Toner L | 0.40 | 55.0 | 69.6 | 68.6 |
| Example 15 | Toner M | 0.40 | 54.3 | 70.0 | 68.0 |
| Example 16 | Toner N | 0.40 | 54.5 | 70.2 | 68.2 |
| Example 17 | Toner O | 0.60 | 54.6 | 70.0 | 63.5 |
| Example 18 | Toner P | 0.60 | 53.6 | 71.2 | 62.5 |
| Example 19 | Toner Q | 0.60 | 53.6 | 71.4 | 62.7 |
| Example 20 | Toner S | 0.40 | 49.0 | 76.2 | 60.4 |
| Example 21 | Toner T | 0.40 | 49.3 | 75.8 | 60.3 |
| Comparative | Process | 0.40 (yellow) + | 45.5 | 67.6 | 56.9 |
| Example 1 | Color YM1 | 0.40 | | | |
| | | (magenta) | | | |
| Comparative | Process | 0.37 (yellow) + | 47.0 | 69.0 | 48.4 |
| Example 2 | Color YM2 | 0.35 | | | |
| | | (magenta) | | | |

(2)

| | | | | | Color Tone |
|---|---|---|---|---|---|
| | | | | | with Black |
| | | c* | H | Color Tone | Light |
| Example 1 | Toner A | 99.3 | 38.6 | Red | Violet |
| Example 2 | Toner A | 107.9 | 43.7 | Red | Violet |
| Example 3 | Toner B | 97.8 | 44.1 | Red | Violet |
| Example 4 | Toner B | 107.1 | 48.0 | Red | Violet |
| Example 5 | Toner C | 95.0 | 41.3 | Red | Violet |
| Example 6 | Toner D | 98.1 | 38.7 | Red | Violet |
| Example 7 | Toner E | 96.8 | 39.1 | Red | Red |
| Example 8 | Toner F | 98.2 | 38.6 | Red | Red |
| Example 9 | Toner G | 98.1 | 38.5 | Red | Red |
| Example 10 | Toner H | 97.6 | 38.5 | Red | Red |
| Example 11 | Toner I | 98.6 | 39.4 | Red | Red |
| Example 12 | Toner J | 99.2 | 38.7 | Red | Red |
| Example 13 | Toner K | 99.1 | 38.9 | Red | Red |
| Example 14 | Toner L | 97.7 | 44.6 | Red | Red |
| Example 15 | Toner M | 97.6 | 44.2 | Red | Red |
| Example 16 | Toner N | 97.9 | 44.2 | Red | Red |
| Example 17 | Toner O | 94.5 | 42.2 | Red | Red |
| Example 18 | Toner P | 94.7 | 41.3 | Red | Red |
| Example 19 | Toner Q | 95.0 | 41.3 | Red | Red |
| Example 20 | Toner S | 97.2 | 38.4 | Red | Violet |
| Example 21 | Toner T | 96.9 | 38.5 | Red | Red |
| Comparative | Process | 88.4 | 40.0 | Red | Violet |
| Example 1 | Color YM1 | | | | |
| Comparative | Process | 84.3 | 35.1 | Red | Violet |
| Example 2 | Color YM2 | | | | |

Toners of Examples reproduce color properties such as brightness, chroma and hue angle unreproducible by conventional process colors.

Although having red color tone, toners of Comparative Examples had low brightness and chroma and could not reproduce red having high chroma and brightness as toners of Examples.

Further, toners including a fluorescent color material maintain color tones under natural light even when irradiated with black light, but toners not including a fluorescent color material change color tones to violet when irradiated therewith.

Having now fully described the invention, it will be apparent to one of ordinary skill in the art that many changes and modifications can be made thereto without departing from the spirit and scope of the invention as set forth therein.

What is claimed is:

1. A red toner for developing an electrostatic latent image, comprising:
a colorant; and
a binder resin,
wherein an image produced by the red toner has a hue angle (H) of from 36 to 50° in L*a*b* color system, a lightness (L*) of from 47 to 55, and a chroma (c*) of from 94 to 108.

2. The red toner of claim 1, wherein the colorant comprises an achromatic fluorescent color material having a chroma (c*) less than 3 or a fluorescent color material having a hue angle (H) of from 80 to 110° in L*a*b* color system.

3. The red toner of claim 1, wherein the colorant comprises at least one of a compound having a diketopyrrolopyrrole structure and a compound having a perylene structure.

4. The red toner of claim 3, wherein a ratio of the total weight of the compound having a diketopyrrolopyrrole structure and the compound having a perylene structure to the total weight of the fluorescent color material is from 4/1 to 2/1.

5. A developer comprising the red toner according to claim 1.

6. An image forming apparatus, comprising:
an electrostatic latent image bearer;
a charger configured to charge the electrostatic latent image bearer;
an irradiator configured to irradiate the electrostatic latent image bearer to form an electrostatic latent image thereon;
five image developers configured to develop the electrostatic latent image with a black toner, a cyan toner, a magenta toner, a yellow toner and the red toner according to claim 1, respectively to form a toner image;
a transferer configured to transfer the toner image onto a transfer material; and
a fixer configured to fix the toner image on the transfer material.

7. The image forming apparatus of claim 6, wherein the cyan toner comprises C. I. Pigment Blue 15:3, the magenta toner comprises C. I. Pigment Red 122, the yellow toner comprises C. I. Pigment Yellow 185, and the black toner comprises carbon black.

8. An image forming apparatus, comprising:
an electrostatic latent image bearer;
a charger configured to charge the electrostatic latent image bearer;
an irradiator configured to irradiate the electrostatic latent image bearer to form an electrostatic latent image thereon;
two image developers configured to develop the electrostatic latent image with a black toner and the red toner according to claim 1 to form a toner image;
a transferer configured to transfer the toner image onto a transfer material; and
a fixer configured to fix the toner image on the transfer material.

9. An image forming apparatus, comprising:
an electrostatic latent image bearer;
a charger configured to charge the electrostatic latent image bearer;
an irradiator configured to irradiate the electrostatic latent image bearer to form an electrostatic latent image thereon;
four image developers configured to develop the electrostatic latent image to form a toner image;
a transferer configured to transfer the toner image onto a transfer material; and
a fixer configured to fix the toner image on the transfer material.
wherein at least 1 to 3 of the image developers comprise a black toner or the red toner according to claim 1.
